(19) United States
(12) Patent Application Publication
(10) Pub. No.: US 2006/0034456 A1
(43) Pub. Date: Feb. 16, 2006

(54) Method and system for performing perfectly secure key exchange and authenticated messaging

(75) Inventor: Paul McGough, Centreville, VA (US)

Correspondence Address: MAYER, FORTKORT & WILLIAMS, PC, 251 NORTH AVENUE WEST, 2ND FLOOR, WESTFIELD, NJ, 07090, US

(73) Assignee: Secure Choice LLC

(21) Appl. No.: 11/108,347

(22) Filed: Apr. 18, 2005

Related U.S. Application Data
(63) Continuation-in-part of application No. 10/062,312, filed on Feb. 1, 2002.
(60) Provisional application No. 60/563,065, filed on Apr. 16, 2004.

(51) Int. Cl. H04L 9/30

(52) U.S. Cl. 380/30

(57) ABSTRACT

A system and method for the cryptographic exchange of information is provided which affords maximum security, process simplicity and participant convenience to any software application, business process or device used to communicate messages. The system provides the ability to openly exchange encryption keys for each communication between participants in a totally secure fashion. Along with the key exchange, the system and method can be used to secure all accompanying message content with a derived message key. The system and method derives the message key in such a manner that the original encryption key cannot positively be determined from a discovered message key. The system and method additionally provide a technique for authenticated exchange of new encryption keys such that the new key is completely dissimilar from any previous key, effectively eliminating any chained key knowledge.

### STATEMENT OF RELATED APPLICATIONS

This application is a Continuation-In-Part and claims the benefit of priority to copending U.S. patent application Ser. No. 10/062,312, filed Feb. 1, 2002 entitled “Method And System For Performing Perfectly Secure Key Exchange And Authenticated Messaging.”

This application also claims the benefit of priority of co-pending U.S. Provisional Patent Application Ser. No. 60/563,065, filed Apr. 16, 2004, entitled “The 2 Factor Authentication System.” Both of the above referenced applications are incorporated herein by reference.

### FIELD OF THE INVENTION

The present invention relates generally to systems and methods for performing perfectly secure encryption key exchanges in connection with an authenticated encrypted message, and more particularly to a system and method for participants in an electronic messaging platform to communicate new data encryption keys in a perfectly secure manner along with other information that is used to encrypt and authenticate a uniquely secured message through any communication avenue.

### BACKGROUND OF THE INVENTION

Conventional electronic messaging systems that use an encryption technique for security do not use any methods that provide absolute, provable security for a one-time key exchange that is combined and connected with an authenticated and uniquely encrypted message using this one-time session key. In order to perform these beneficial and related functions, one must currently use two distinct methods: (i) public key encryption (which is not provably secure) to perform the key exchange; and (ii) a secret key encryption technique to use that key to encrypt the message. Because these two systems are unrelated, so, too is the authentication. Along with the vulnerabilities and inherent difficulties introduced by the combination of these two unrelated systems (which vulnerabilities include man-in-the-middle attacks, performance issues in the electronic infrastructure, complexity of the applications to handle multiple techniques, and imperfect mathematics that is susceptible to methods other than brute force and ever increasing computational speeds), the unacceptable disadvantage of these combined techniques is that the user of these systems is made to perform complex and unnatural behavioral modifications. As a result, the user frequently fails to follow these techniques correctly, thus compromising the security of the system and diminishing its value.

There thus remains a need in the art for a single, related system that delivers singular key use to uniquely protect message data while combining a simple, perfect exchange of that singular key. In particular, there is a need in the art for a system and method to combine authenticated message encryption and perfectly secure key exchange into a single asymmetric transmission between messaging participants.

There is also a need in the art for a system and method that, while combing these two necessary steps into one, can relate one key to the next such that the key chain never delivers a definitive formation even if an unintended party learns the identity of a particular key in the chain.

There is also a need in the art for a system and method that uses the perfectly secure exchanged key to encrypt an accompanying language-based message, such that there is provably only one manner in which to determine the contents, which is to attempt all of the possible key combinations (i.e., a brute force attack).

There is also a need in the art for a perfectly secure key exchange using this methodology such that the chained key relationship is re-started in a manner that is indecipherable even when a key exchange message is known to be sent.

These and other needs are met by the present invention, as hereinafter described.

### SUMMARY OF THE INVENTION

In one aspect, the present invention relates to systems and methods for the perfectly secure exchange of numeric encryption keys, provided a shared numeric secret already exists between exchange participants, and for the authenticated encryption of any accompanying message content.

According to one aspect of the present invention, a single linear equation is used at least two, and initially three times, in succession to exchange new keys as undecipherable derivations of the existing shared secret, and a straight-forward process, using one of the undecipherable key derivations, is then used to encrypt any additional information bundled as the message content.

In accordance with an exemplary embodiment, a shared numeric secret exists between messaging participants. The shared secret is a string of characters, and preferably is a number of either decimal or hexadecimal content, such as “1234” or “3D5F”. This original shared secret, called the Existing Secret (ES), is preferably distributed in secret prior to the use of this embodiment using a suitable distribution method (e.g., through phone, email, mail, physical exchange, or by being embedded in a device). If the ES is not of sufficient length, as determined by the current length definition of the time period of use, then this system provides for a Trusted Exchange (TE) of a new proper length ES with only the knowledge of the current ES required by the participants.

This exemplary embodiment may be understood with reference to a system in which there are two message participants, hereinafter termed “Alice” and “Bob”, along with a third, unauthorized participant “Eve”, who has no knowledge of the ES. The system will allow Alice or Bob to send a message to the other that is indecipherable to Eve, and in so doing, exchange new keys by deriving the new keys from the ES using a simple linear formula and a straight-forward process. The derived new keys include one to be the new Existing Secret for the next future message and another to be the unique Message Key (MK) to be used to encrypt this message's accompanying content.

In another aspect, the present invention relates to a system and method of the type described above for the provision of secret messaging between two participants who are unknown to one another, but are known to a specific contact point in the system in which both participants are communicating. In accordance with the system and method, each participant is connected to the system with an ES prior-secret relationship, and while they are unknown to one another, they communicate in secret as previously described above with their known contact point which then communicates also as described above with other known contact points until reaching the contact point that knows the intended recipient. This contact point is then also communicated with as described above, and he finally communicates with the end-recipient. Thus, for example, if Alice wants to communicate with Bob, whom she does not have an ES prior-secret relationship, but she does have such a relationship with Point A in the network, and if she knows that Bob is at least also on the network, then she communicates in secret as described above with Point A, whom she instructs to find Bob. For example, Point A might “know” (i.e., have an ES prior-secret relationship) Point B, which knows Point C, which knows Point D, which knows Bob. Hence, Alice can communicate with Bob indirectly by utilizing this chain of existing ES prior-secret relationships. In so doing, each Point in the chain communicates Alice's message to the next Point in the chain using ES prior-secret relationships, until finally Point D communicates the message to Bob, with whom it has an existing ES prior-relationship.

In still another aspect, the present invention relates to a system and method of the type described above wherein, after a unique MK is created and exchanged, the system will encrypt the accompanying content using a variable portion, up to and including the entirety, of this unique MK in a manner that includes one of two different key expansion techniques, and at least one, and preferably two, different transposition processes.

In still another aspect, the present invention relates to a system and method of the type described above which is used only for communicating as a key exchange system to generate the next future message's new ES and the unique MK. Instead of using this method's encryption technique for the accompanying message content, another system is used to encrypt the accompanying message content. In some embodiments of this aspect of the invention, a predetermined accompanying content will be used to exchange a new ES for the next future message.

In another aspect, the present invention relates to a method for exchanging secure messages between two parties, comprising the steps of receiving a first sequence of characters, operating on the first sequence with a first algorithm at least twice in succession, thereby forming second and third sequences of characters, encrypting a message through the use of at least one of the second and third sequences, thereby forming an encrypted message, and sending the encrypted message, and preferably the second and third sequences, to a recipient.

In a further aspect, the present invention relates to a method for exchanging secure messages between three parties based on a first existing sequence of characters known to a first and second party and a second existing sequence, distinct from the first existing sequence, which is known to the second and third party. The method comprises the steps of generating a first encrypted message through the use of a first encryption key derived from the first sequence of characters, generating a second encrypted message from the first encrypted message through the use of a second encryption key derived from the second sequence of characters, and decrypting the second encrypted message through the use of a third encryption key derived from the second sequence of characters.

In another aspect, the present invention relates to a method for exchanging secure messages between two parties based on an existing sequence of characters, comprising the steps of operating on the existing sequence with a first algorithm at least two times, thereby forming first and second sequences of characters, encrypting a first message such that it can be decrypted using the first sequence, thereby forming a first encrypted message, and sending the first encrypted message and the second sequence to a recipient, wherein the recipient operates on the second sequence with the first algorithm to generate third and fourth sequences of characters.

In a further aspect, the present invention relates to a method for exchanging secure messages between two parties, comprising the steps of receiving an original sequence of characters; operating on the original sequence three consecutive times with a first equation, thereby forming first, second and third sequences of characters, respectively; operating on one of the first, second and third sequences with a second equation, thereby creating a fourth sequence of characters; and encrypting a message through the use of the fourth sequence of characters.

In still another aspect, the present invention relates to a method for exchanging encryption keys, comprising the steps of receiving from a sender a first message encrypted through the use of a first encryption key; decrypting the first message through the use of the first encryption key; operating on the first encryption key with an equation so as to produce a second encryption key; encrypting a second message through the use of the second encryption key, thereby creating a second encrypted message; and communicating the second encrypted message and the second encryption key to the sender.

In another aspect, the present invention relates to a method for exchanging encryption keys, comprising the steps of (a) providing an encryption key defined as a first sequence of characters; (b) operating on the key with a first equation so as to produce at least a second and third sequence of characters; (c) encrypting a message through the use of at least one of said second and third sequences of characters, thereby creating a first encrypted message; (d) communicating the first encrypted message and the second and third sequences of characters to a recipient; (e) redefining the encryption key as said second sequence of characters; and repeating steps (a) through (e) at least once.

In a further aspect, the present invention relates to a method for exchanging message keys between two parties based on an sequence of characters known to the parties, comprising the steps of operating on the existing sequence of characters with a first equation at least two times, thereby forming a first and second sequence of characters; creating a message containing first and second parts, wherein the first part of the message comprises the first and second sequence of characters, and wherein the second part of the message comprises a message text; encrypting the message, thereby forming a first encrypted message; and sending the first encrypted message to a recipient.

In another aspect, the present invention relates to a software program or set of programs which are disposed in a tangible medium, and which contain instructions suitable to carry out any of the above noted methods, or any portions thereof.

In yet another aspect, the present invention relates to a system adapted to carry out any of the above noted methods, or any portions thereof.

These and other aspects of the present invention are described in greater detail below.

### BRIEF DESCRIPTION OF THE DRAWINGS

FIG. 1 is a flowchart illustrating an embodiment of the methodology of the present invention.

FIG. 2 is a flowchart illustrating an embodiment of the methodology of the present invention.

FIG. 3 is a flowchart illustrating an embodiment of the methodology of the present invention.

FIG. 4 is a flowchart illustrating an embodiment of the methodology of the present invention.

### DETAILED DESCRIPTION

As used herein, the term ‘perfectly secure’, when used in reference to a key exchange, means that there is no way to derive the keys used in the exchange other than through a brute force algorithm (which, logically, is always available).

As used herein, the term ‘provable security’ means that the mathematics of the exchange dictate that the only solution available is the intended one.

In accordance with the present invention, a perfectly secure key exchange and authenticated messaging system and methodology is provided for encryption key distribution, management and message protection. The system and methodology overcome a number of infirmities in existing systems that are designed for secure messaging. For convenience, the system of the present invention will frequently be referred to as the Krypt eXchange Protocol (KXP), and components or portions of systems and methodologies in accordance with the present invention may be referred to by similar or derivative names, it being understood that the present invention is not limited in any way by any products or services that may be sold or marketed under that name or designation, either now or in the future.

The system of the present invention will typically include software components, which may be written in multiple programming languages for operation on a variety of computer operating systems or platforms. Hardware components may also be provided that may be built to facilitate the use and deployment of the system and methodology of the present invention in multiple electronic devices.

In the preferred embodiment of the system of the present invention, a set of software referred to as a KXP Toolkit is used to provide a security layer to other software applications, business processes or electronic devices. This security layer acts to secure communications between the user of the device, application or process and another user or an owner of the content within the device, application or process. The KXP Toolkit preferably requires that all communicating participants have a single, original Existing Shared Secret that is in a Base 10 or Base 16 number format and preferably of at least 10-digits or characters in length. These numbers can be represented in either a “macro” format, such as an account number, or in electronic format in a minimum of 4-bits each, such that the minimum recommended number of bits for the Existing Shared Secret (ES) is 40-bits.

These ES numbers will preferably have been initially distributed to each participant outside the scope of the KXP using existing distribution and registration processes such as exists for the initial distribution of a credit card and its ES, which is typically the account number. Along with the ES, an OpenID number or character string is provided that associates any secure communication to the ES and owning participant. If desired, the format of such OpenID can be application, device or process dependent. As explained in greater detail below, the KXP process allows for the secure exchange of future encryption keys based on existing encryption keys or an ES, even if the existing encryption keys or ES has been compromised. Hence, additional security can be imparted to the system by requiring that the first communication between parties, prior to the exchange of any substantive message, is a key exchange to establish a new ES that can be used in the exchange of the first substantive message. Additional security can also be imparted to the system by requiring periodic or random key exchanges between parties, even if the parties are not actively exchanging substantive messages, since this makes derivation of any particular key set by a third party significantly more resource intensive.

In order to understand the KXP as a process for key exchange and encryption, a few system fundamentals (functions or primitives) of one particular embodiment of the system are provided:

System Primitives (Functions)

1. KXPE (Krypt eXchange Protocol Equation)
(x+y) Mod baseX=7 where x and y are baseX numbers (X being any integer value, normally 10 or 16), either single digits or individual digits of a larger number

2. LKES (Limited Knowns Equation Set)
(a+7) Mod baseX=b
(b+c) Mod baseX=9
where a, b and c are single digits (or individual digits of a larger number) of any baseX

3. OWC (One-Way Cut)
Contracts a number by adding paired digits using the KXPE; the selection spacing can be any Separation Value (SV) such that all the numbers are paired and used only once.
(a(1)+a(2)) Mod baseX and (a(3)+a(4)) Mod baseX, and . . . and (a(n−1)+a(n)) Mod baseX for a result of b(1,2,3,4 . . . n).

4. NEK (Never Ending Key)
Expands a number by modulus baseX adding digit pairs determined by the offset of the digit values themselves, then using an increasing pointer on the offset, then using one of the pointer cycles as the new expansion number, resulting in a continuous, non-repeating number stream with final size determined by use.
a. Using a pointer begun at digit position one that cyclically moves to the right one digit for each calculation, take the value of the number digit at the pointer, and modulus baseX add the digit value at the position found to the right (offset) where the ‘zero position’ is the first one to the right, ‘position one’ is the second to the right, etc. (circling back around the digit if this moves “off the end” of the number)
b. The resulting value is the next NEK digit in the stream. When the pointer has moved through all of the digit positions, add one position to the selection criterion for the ‘value to the right’ or offset (e.g., instead of selecting the digit position for the mod add found by the pointer's position value that many offset digits, use the offset plus one)
   i. This method, Increment Method 1 (IM1), is to increment selection after the offset; a second method, Increment Method 2 (IM2), can be to increment the offset selection while beginning at the same position—either works equally ‘randomly’; e.g., the equation sets for the final values are still KXPE unsolvable, and the distribution as the number expands is still position oriented, not mathematically oriented
c. When this cycle pointer has generated all of the mod adds in each cycle (adding one to the cycle pointer for each sequence) and it is now greater than the original length of the original number, replace the original number with the digit sequence that resulted when the cycle pointer value is equal to the digit value in position one of the original number
d. Continue through this new number for all of the cycles, and then replace it in the same manner, continuing ‘forever’
NEK(a(1,2,3,4))=b(1,2,3,4,5,6,7,8,9, . . . )
For example, NEK(1234)=(1+3) and (2+1) and (3+3) and (4+1) and (1+4) and (2+2) and (3+4) and (4+2) and . . . continuing until the cycle pointer is greater than 4, and then replacing 1234 with 5476 (which is the number generated from the first number's cycle “1”, from the first digit) and beginning again with (5+7) and (4+7) and . . . all Mod 10 until the desired length is reached for 43655476 . . . 21 . . . end
An example:

NEK(a)=27163904882901 . . . . Begins with these possibilities (decimal example):

| | |
|---|---|
| 02_{— — — — — — — — —} ... | These 10 possibilities all result in the “2” |
| from the | |
| 1_1_{— — — — — — — —} ... | stream. And then to meet the “7”, one can |
| place a | |
| 2_{— —}0_{— — — — — — —} ... | 07 in digit positions two and three in eight of |
| these | |
| 3_{— — —}9_{— — — — — —} ... | possibilities, a 1_6 can fit into seven of |
| them, a | |
| 4_{— — — —}8_{— — — — —} ... | 2_{— —}5 can fit into six, etc. |
| 5_{— — — — —}7_{— — — —} ... | The end result? The choices quickly become |
| 6_{— — — — — —}6_{— — —} ... | overwhelming and never positively correct. |
| 7_{— — — — — — —}5_{— —} ... | |
| 8_{— — — — — — — —}4_{—} ... | |
| 9_{— — — — — — — — —}3 ... | |

e. The NEK may be further complicated by keeping secret the length of the original number, as there is no identifiable division in the expansion stream of any cycle start or end
f. For a NEK of a specific length, the function may be complicated even more by selecting the index of where to start within the original number, and the value of the pointer; the cycle can also be chosen with some additional calculations required to realize the seed number—the seeds need to be generated in sequence to arrive at the correct one first.

5. PK (Position Key)
Expands a number using the NEK function, except it uses a second number as the offset instead of the number itself. The first number to be expanded is called the Value Key (VK), and the second number is the Offset Key (OK)
PK(c([c(1), a(1)] and [c(2), a(2)] and [c(3),a(3)] and . . . ))=b(1,2,3,4,5,6,7,8,9 . . . )

6. ML (Matrix Lookup)
Use two index numbers to return two positions in a Matrix Lookup, and then KXPE sum those for a single result.

Example: Using the following hexadecimal matrix

| | | | |
|---|---|---|---|
| P(0) = 3 | P(4) = 7 | P(8) = 9 | P(C) = 1 |
| P(1) = 1 | P(5) = 3 | P(9) = 3 | P(D) = B |
| P(2) = 4 | P(6) = A | P(A) = D | P(E) = 0 |
| P(3) = 9 | P(7) = 2 | P(B) = 2 | P(F) = 8 |

and the KXPE formula where (P(i1)+P(i2)) Mod 16=7, can one determine (positively) i1 and i2?
The ML varies per square, with the number of possibilities varying for any particular summed result. The numbers cannot positively be identified, because there are multiple possibilities for both numbers. For example, when i1=0, then i1=2, but also i1 could equal E when i2=4. Each square must be totally known, along with the KXPE result, in order to calculate the ML for every available set of i1 and i2 possibilities, of which there will be multiple pairs equaling the same KXPE result.

### EXAMPLE 1

### The KXP System in Principle (Logic)

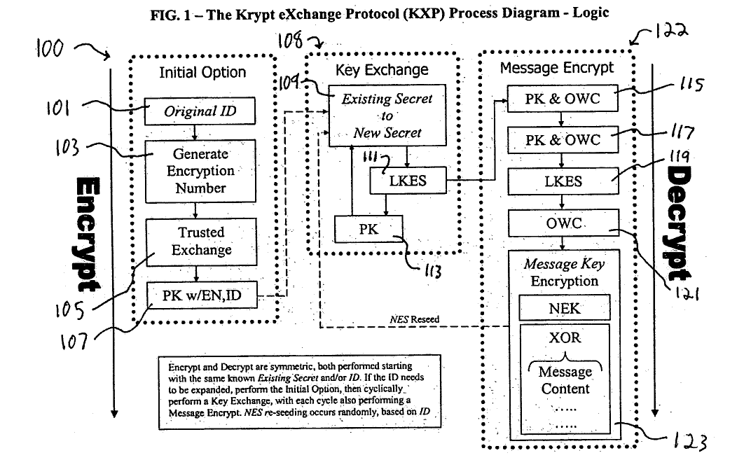

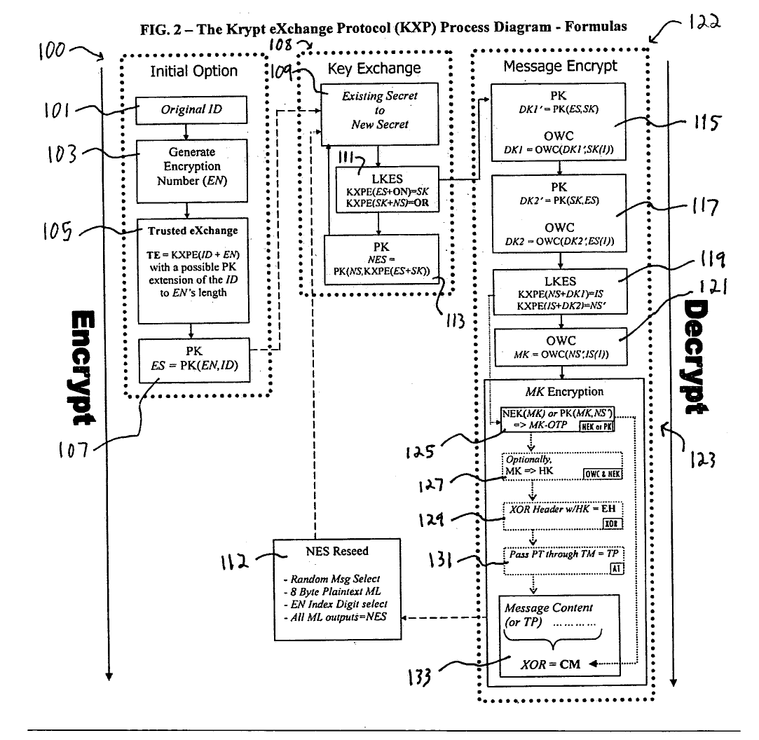

The following exemplary embodiment of the KXP illustrates the logic process of the system. FIGS. 1-2 illustrate this process schematically.
1. Begin (100) with an Existing Shared Numeric Secret (ID) (101) between a participant and a receiver
   A. If the ID is too small to be effective alone, and/or if it needs to be absolutely protected, then perform a Trusted Exchange (105) which generates the initial Existing Secret starting point for secure messaging based on an Encryption Number (EN) (103).
      i. LKES(ID, Encryption Number)=TE open, authenticated exchange (e.g., trusted—if not authenticated, system simply doesn't work, but is not broken)
      ii. PK(ID, EN)=Initial Existing Secret (ES) (107)
2. For each and every secret communication, asymmetrically sent between the participant and the receiver originating from either one, perform the following key exchange, maintenance and encryption process (108):
   A. Perform a Key Exchange of a New Existing Secret (NES) to be used in place of the last Existing Secret (109):
      i. Perform LKES(ES, OpenNumber)=new, indeterminate key material (111)
         Seed Key (SK), New Secret (NS) and includes an OpenReturn for receiver decryption (NES Reseed if necessary (112))
      ii. NES=PK(NS, LKES (ES, SK)) (113)
   B. Create a unique Message Key (MK) to be used as the base key for the message content
      i. Data Key 1 (DK1)=OWC(PK(ES, SK)) (115)
      ii. Data Key 2 (DK2)=OWC(PK(SK, ES)) (117)
      iii. Unique, one-time only MK=OWC(LKES(NS,DK1,DK2)), (119, 121) resulting in an MK that is ½ the length of the ES
   C. Encrypt the message (122) content with the MK (123), which authenticates and provides integrity and continuity, using either a known cipher, or a Practical One Time Pad (P_OTP) technique (125):
      i. Without requiring transmission, create an MK_P_OTP of full byte key characters using a NEK(MK), and optionally an Alphabet Transposition (AT) that is rotated by cyclic MK key digits as offsets for any key re-use collision, only if MK_OTP expansion is performance-driven to be shorter than the plaintext
         a. AT is exchanged in a message Encrypted Header (EH) by performing an XOR with the Header Key (HK) (129), which is created by NEK(OWC(MK))
      ii. Ciphertext=Optionally, Plaintext (PT) sent through AT (131) to generate Transposed Text (TT), and then either the TT or the PT in an XOR (133) with the MK_P_OTP
   D. Asymmetrically send the OpenNumber, OpenReturn, optional EH and the Ciphertext to the recipient
3. Decryption is a simple replication of the process based on the recipient having perfect knowledge of the ES or ID and the open outputs. Both participants will store the new ES (NES) for the next message.
4. Cyclically, the NES can be re-seeded using message content, from a sequentially selected message using a specified digit of the KXPE(EN, First ES) result
   A. Use two other specified digits of that result to determine the message content starting point for the reseed
   B. Place the content in 4-bit hex number representation blocks into a Matrix Lookup (ML) of 16 positions, such that 64-bits of message content makeup one ML
   C. Use sequential digits of the KXPE(EN, First ES) result (or just the EN) as pointers into the ML, selecting two position values out of each ML
   D. Perform KXPE(ML_Return1,ML_Return2) to generate a single new NES key digit
   E. Repeat the ML selection using the next 64-bit block, pointers and function results until the required length NES is returned—in this NES creation, the ML content can be considered as known, yet the reseeded NES will be secure
      Conclusion

The KXP has delivered a secure, authenticated key exchange, secure communications that even if discovered retains the sanctity of the original secret, and a capability to communicate new secrets at will. The KXP system provides all of this, in a performance-enhancing single asymmetric transmission. The system uses provable, efficient and simple mathematics and cryptographic techniques to accomplish all of its goals without introducing any new participant requirements or “expert knowledge”. The KXP is a compact, single transmission system that is performance enhanced by the simple formulas and is future computing-assured with known, well-identified attacks and remedies.

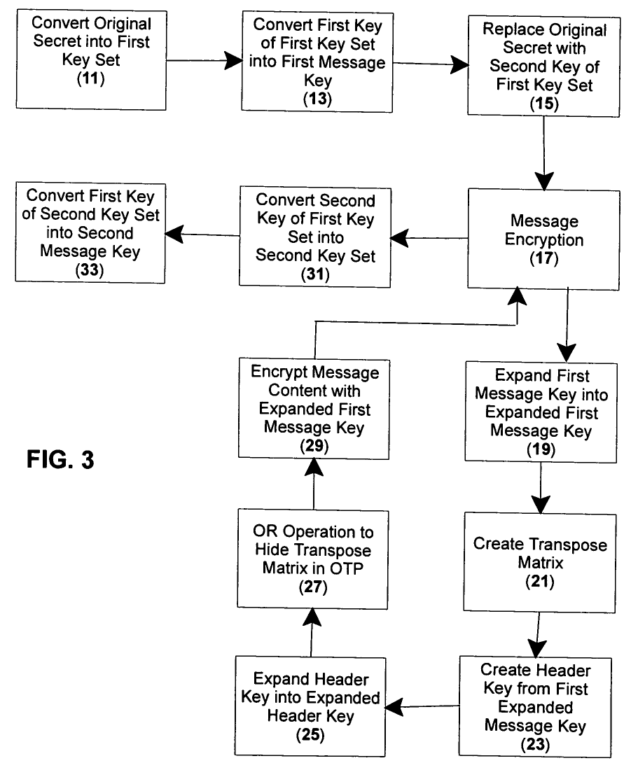

The present invention can be further understood with reference to the flowchart of FIG. 3, which illustrates one non-limiting example of a system having some of the features described above. After an Original Secret has been established, it is converted 11 into a first key set by a user. A first key of the first key set is then converted 13 into a first message key. The Original Secret is replaced 15 by a second key taken from the first key set. Message encryption 17 is then accomplished by expanding 19 the first message key into an expanded first message key, creating 21 a transpose matrix, creating 23 a header key from the first expanded message key, expanding 25 the header key into an expanded header key, using the expanded message key in an OR operation to hide 27 the transpose matrix in an OTP, and encrypting 29 the message content with an expanded first message key. A second key of the first key set is then converted 31 into a second key set, and a first key of the second key set is converted 33 into a second message key.

### EXAMPLE 2

The following example illustrates some of the details of one particular embodiment of the KXP Process. In this example, it is assumed that Alice and Bob know secret A, which is a number with an even number of digits that is at least 10 digits in length.

Encryption:

The following encryption scheme is used:
1. Start with an already distributed shared secret; an existing shared numeric key (Existing Secret ES) and perform the Initial Option, if required
   Numerous systems exist with this criterion—credit cards, personal devices, etc.
   In order to use these already distributed shared secrets, when one wishes to ‘join’ a KXP cloud (key store), there is/will be a registration process
   The ES will be composed of numbers represented in 4-bits of up to a hexadecimal number, with a time-period defined n-bit (X hex numbers) minimum; this may be, for example, 256-bits (64 hex numbers)
   If the existing number is too short in length (or only decimal) to be used as an encryption key and the registration process cannot or will not handle the distribution of a proper length new ES (the Preferred Strategy for initial ES setup), then perform the Initial Option which includes a Trusted Exchange (TE) procedure to lengthen the short ES for initial use:
      Preferred Strategy—distribute an out-of-band n-bit Existing Secret ES equal to four times the digit length of the required Message Key (MK) where MK will be time-period computationally implausible. Split this ES into two halves, using the first half as the ID throughout the KXP, and the second half as the EN. Both of these halves are exponentially larger than the MK, and therefore a brute force is ‘impossible’ (as measured in practical key space searching). This should be no more systematically difficult than PKI certificate distribution, or original Credit Card distribution systems; and like those systems, it only has to be done once.
      Initial Option—
         Use an Existing Secret ES that is already distributed or embedded in a device (ESN or IMEI in a cell phone, a Credit Card number, Account Number, etc.) of at least 10 digits (hex preferably, but decimal is acceptable)
         Register this number, if not already, with the system connection point in the KXP cloud (this device's/person's key store) in an out-of-band manner and associate a key store CustomerID (CID) that will be used within the key store to identify this KXP participant and retrieve the proper key sequence for any secret messaging
         At the registration point, have the device (or user) randomly generate a number (called the Encryption Number—EN) whose digit length is twice the required MK length (this brings the number to an even number of digits, which is the useable length of any KXP key whether the short ID is comprised of an odd number of digits or not)
         Exchange (out-of-band, or openly either manually or through the device) the KXPE sum of the ES and the extended number (EN) with the key store
            KXPE(ID+EN) using Mod 16 as the EN is always hex
         This exchange is called the Trusted Exchange (TE) in that it is not imperative that the TE result be kept secret, but it must be authenticated. If it is captured and held, it is acceptable in that a KXPE output does not lend itself to any input decipherment. And it is also acceptable if the result is tampered with during the exchange—because if it is, the participant will not be able to ever send a message correctly (nothing is stolen, but also the KXP will not work; so this is simply a nuisance interference, not a security violation).
         It is quite possible that the Original ID doesn't have enough length to sufficiently produce enough TE output without having to recycle itself. When this is the case, in order to begin creating the TE digit immediately after the KXPE sum of the existing ID and EN numbers, expand the ID to an ID-Full:
            Use a ‘modified’ PK where the start of the VK is the first EN digit and the VK length is the EN up to the matching length of the ID; use the ID as the OK
            As each PK digit is created, then concatenate it to the ID (creating ID-Full) and KXPE add it to the corresponding digit of the EN
            Extend the VK, and move the selection pointer one digit, as each digit of the PK is created
            For example:
            ID=1234abcd where abcd will need to be the extended digits EN=07293861 TE=1953 to start
            a=0+2=2 where the “0” is digit one of the VK (currently 0729), and the OK is “1” from the ID
            b=7+3=0 where the “7” is digit two of the VK (currently 07293), and the OK is “2” from the ID
            c=2+0=2 where the “2” is digit three of the VK (currently 072938, and the OK is “3” from the ID and we need to cycle back around the VK to use the 0
            d=9+7=6 where the “9” is digit four of the VK (currently 07293861), and the OK is “4” from the ID and we need to cycle back around the VK to use the 7
            ID-Full is then 12342026, and the full TE, exchanged in a trusted manner, is then 19535887
            Now to create the first, initial Existing Secret (ES), perform a PK with the full length ID-Full as the VK and the EN as the OK ES=PK(ID-Full, EN)
2. Perform secure Key Exchange
   Create a key set of three unknown keys using an LKES (and two knowns)—Existing Secret (ES), Seed Key (SK) and New Secret (NS) and Open Number (ON) and Open Return (OR)
      (ES+ON) Mod baseX=SK
      (SK+NS) Mod baseX=OR where the NS is randomly generated
   PK (Positional Key) function using the Value Key (VK)=NS, Offset Key (OK)=KXPE(ES+SK), the result is the new (or next) ES, the NES
      PK(NS, KXPE(ES+SK))
   Randomly, the NES chain will be reseeded by performing a NES Reseed (NES-R)
      NES Reseed (NES-R)
         The KXP exchanges new keys (ES and MK) for every message and authenticates that exchange with content encryption. But it is also possible to ‘break’ the NES exchange (and chain) by deciphering one through brute-force or a guess (even though at an exponentially greater than already improbable MK key space)
         Therefore, it is beneficial to reseed the NES chain at random intervals (from an opponents perspective) such that even after a small series (or just one) of NES keys, the chain would be reset such that the entire new series would begin again at NES and MK key spaces (a broken NES leads to a trivially broken MK, but a broken MK does not trivially lead to the NES chain—this requires exponentially greater effort, equivalent to the brute force of the ES to start)
         Using the plaintext message content of the chosen random message as a salt value in the reseeding process does this. This is cryptographically thought to be a weak process, but immediately this danger can be dispelled because the plaintext of the message will be treated as if it were a known value. It will not be, due to the randomness of the selection, but the assumption will be that this is the case, removing the regular danger of using already transmitted information as key values.
         The NES-R process:
            Use a digit of the Original ID to determine which out of the 10 or 16 (the base of the ID will determine this) will be the next random NES-R message for this process. Keeping a message count (by both sender and receiver) is relatively simple, and when Count Mod_ID_Digit is 0, then the NES will be formed by this NES-R process instead of the LKES/PK usual technique. The system format for the selection of the NES-R frequency can be changeable, as by moving through the ID digits for the message selection criteria in order, or using the digits themselves to move within the ID and then selecting that digit to determine the message; or it can be static for all participants, or may utilize a static digit, such that there is a pattern, but it is individual for each participant (knowledge by an opponent that a particular sequence is being used is irrelevant, just as it is which message is actually selected: it is preferred to make this another difficult step for an opponent, but it is alright if it is not)
            When within the count, and a participant knows that this message is a NES-R message, then begin the plaintext selection by using the next two digits in the ID as the starting point within the message for the first byte in the NES-R. (In total, using a hex ID, this is 16*256=4096 possible starting points in the chain to begin byte selection)
            Using each byte to represent 2 hex numbers (4-bits each), select 8 byte blocks in succession to fill a Matrix Lookup (ML) square in position order from P(0) through P(15). In total, in order to reseed the entire NES, one will need to use (2*#-of-bits-in-NES) bytes. If the message does not have that many, then start at byte one instead of the offset selection. If still not enough, cycle around and re-use the bytes (remember—these are treated as a known value already, so this is not an information leak)
            Use a modified ML index selection in that, instead of using two Index Digits to return a single sum, simply use one Index Digit to return the value in the ML position matching the Index Digit; the Index Digit comes from using the EN digits in cyclic fashion beginning with the first (or system defined start—which can be ‘randomized’ using digits from the ID as the selection criterion as already shown)
            Repeat ML fill using the next 8 byte block, return the Index Digits choice, and cyclically repeat until enough digits are returned to equal the NES length
            The NES will be formed simply by concatenating all of these ML returns together
            The security of this reseeded NES is that, first, it must be broken again at that exponentially great key space, since even knowing the message, the start point, and what the ML makeup is, does not help. This is because the EN is totally unknown (and irrefutably hidden in the original KXPE in the TE), so it is impossible to tell which digit is returned. If one does know the exact ML makeup (the system should be setup so this is not known), since all the MLs will not contain all numbers, one can limit the possibilities for the NES digits (e.g., if there are only 9 out of 16 digits represented in an ML, then that position of the NES will only have that probability). This still requires one to break the NES, but it is possible to decrease, only marginally, the key space to search; it will, with normal distributions of plaintext, still be exponentially larger than a MK search, but possibly less than a full NES search. If one does successfully break this new NES chain again, one still cannot positively configure the EN, as there will be multiple ML squares with multiple digits. Consequently, one would have to repeat this NES break multiple times and still never limit the NES totally.
            Should some KXP implementations require assurance that this cyclic brute force of multiple ‘impossible’ key spaces does not occur, a ‘regular’ ML Index Digit setup may be used of two digits returning a sum out of the ML (which has as much repetitive possibilities as single digit returns), and where the two digits are formed by summing the EN digits into pairs (where 4 EN digits are required to return a single ML output). This would require cycling through the EN four times to return enough NES digits. However, even if one does the previous multiple NES breaking and mapping, one is left with digit pairs that cannot ever be positively identified (KXPE logic applies) (with respect to ID digit uses, it should be noted that, if one wishes to be certain that none of these ID digit uses will be traceable such that the ID could be exposed, then one can simply use digit sums as the single digits for selection; e.g., one can use a OWC (KXPE(ID)) such that the original ID digits can never be determined].
3. Perform Message Encryption
Create a unique, one-time only message key (MK) to encrypt the content of this message
   PK function using VK=ES, OK=SK, returning a result that is twice the ES length; this result is called DK1′ (Increment Method (IM) determined by odd (IM1—select then increment) or even (IM2—increment select) of the OK)
      DK1′=PK(ES, SK)
   OWC (DK1′, [SV]) using an optional Separation Value (SV) with this result called DK1
      DK1=OWC(DK1 [SV could be SK(1)])
   This OWC function is performed by:
      Start on digit one of the DK1′
      Modulus baseX add digit one with the digit offset to the right that many spaces defined by the SV, where one digit to the right is SV=0
      Perform this paired sum in cycle, moving one digit to the right in the DK1′ result using the next available, non-used (not yet summed) number until all numbers have been paired such that the DK1 key is ½ the length of its VK
      Should the SV not evenly divide into all of the digits, such that there are left over digits not yet paired (and that cannot be summed using the SV), then these digits are simply adjacently KXPE summed
   PK function using VK=SK, OK=ES, returning a result that is twice the ES length; this result is called DK2′
      DK2′=PK(SK, ES)
   OWC(DK2′) with the result called DK2
      DK2=OWC(DK2)
   LKES using the NS and DK1 and DK2
      (NS+DK1) Mod baseX=Interim Solution (IS)
      (IS+DK2) Mod baseX=NS′
   OWC(NS) with the result being the Message Key (MK)
      MK=OWC(NS)
In order to encrypt the message content uniquely with the MK, any acceptable cipher can be used here, or the KXP method may be used:
   Use the NEK function, with index (1^{st} digit), pointer (2^{nd} digit) and cycle parameters (3^{rd} and 4^{th} digits), to expand the MK such that it becomes a One Time Pad (OTP) key of at least the message length (MK-OTP) where the NEK digits are paired to create a byte key character for each byte of the message content (e.g., the NEK must expand the MK to return twice the message byte-length number of digits)
   Optionally, use the PK function for this expansion, where the VK is the MK and the OK is an OWC(MK w/SV=0, which is adjacent digits)
      Use an XOR and/or a one-time Alphabet Transposition (AT) to encrypt the message content with the MK-OTP. The AT, if used, is simply a matrix that re-arranges the 256 electronic ASCII characters such that, for example, ASCII 001 would be 213, 046 would be 134, etc. This one-time transposition order can be rotated by cyclic MK key digits as offsets if the MK_OTP expansion is performance-driven to be shorter than the plaintext, and where there would then be key re-use collisions. For instance, if MK digit 1 is “5”, then ASCII 001 would now be 218, 046 would be 139, etc.; then for the third rotation and MK key re-use, if MK digit 2 is “B” (11 in decimal), then ASCII 001 would be 229, etc.
      If an AT is used, or if any other information needs to be exchanged for this message such as useable (out of available) Value Key lengths, then create a Header Key (HK) to uniquely XOR encrypt it
         Determine the length of the Header (256 bytes for the alphabet order, n bytes for the VK lengths, n bits for the index, pointer and cycle parameters)—order and format of the Header is system defined
         OWC function the original MK, using MK(1) as the SV, and NEK expand the result to the required just defined length creating a Header Key (HK) (or optionally PK expand using the original MK as the OK)
         XOR encrypt the Header with the HK; the result is the Encrypted Header (EH)
         Pass the plaintext (PT) through the Transpose Matrix (TM) resulting in Transposed Plaintext (TP)
      XOR encrypt the TP, if created, or the PT using the MK-OTP, resulting in the Ciphertext Message (CM)
4. Identify the message with a unique, random open MessageID (MID) for audit and control purposes
   Preferably, this is a 16-digit, hexadecimal number, as that is a large enough key space to uniquely identify messages in any large system
   The MID can also be sequential, if required
5. Identify the message with an open CustomerID (CID) that uniquely identifies which original or last shared secret to use to open this message
   Format system defined (determined during initial registration, or using a system preformatted one such as a telephone number, birth date, etc.)
6. Send the Total Open Message (MID, CID, ON, OR, [EH], CM) asymmetrically in either direction by any participant who has knowledge of the pre-shared ES or last NES

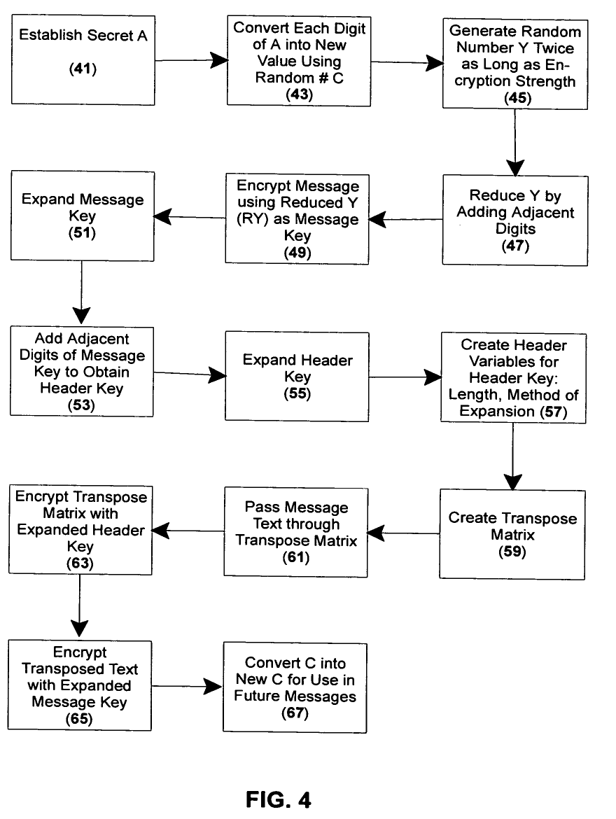

Various encryption algorithms may be used in the practice of the present invention. One such algorithm is depicted in FIG. 4. As shown therein, the process assumes that a secret A has been established 41 between two parties, and that this secret comprises a plurality of digits. Each digit of A is then converted 43 into a new value, as through application of a modular arithmetic equation using a random number C. Next, a random number Y is generated 45 which is twice as long as the required encryption strength. This number is then reduced 47 by half through modular addition of adjacent digits. The reduced Y is then used as the message key to encrypt 49 a language-based message.

After message encryption, the message key is expanded 51, and a header key is obtained by adding 53 adjacent digits of the message key. The header key is then expanded 55, and header variables are created 57 which may indicate, for example, the technique or techniques used to expand the header key, the length of the message key, and the length of the One Time Pad, if one was used in the encryption.

Next, a transpose matrix is created 59, and the message text is passed 61 through the transpose matrix. The transpose matrix is then encrypted 63 with the expanded header key, and the transposed text is encrypted 65 with the expanded message key. Finally, C is converted 67 into a new C for use in encrypting future messages, as through the transposition of certain digits in C and/or the exchange of digits in C with numbers generated by various formulas.

Decryption:
1. Use the CID to lookup the appropriate Shared Secret (Existing Secret ES) for this sender—this might/might not be done by the final destination participant, but regardless, the decrypt process is identical throughout the KXP ‘cloud’
2. Then use the ES and the open ON and OR to decrypt the content and store the New Existing Secret
   Recreate the LKES and MK using the open values, and the starting shared secret, to create the unknowns
   Decrypt the message contents—unsuccessful decryption means unauthenticated, tampered message, or ‘lost key’ message (sent with a key not in recipient's chain)
   Create the New Existing Secret using the LKES key material
   Store the NES as dID the Sender, and per system requirements

### EXAMPLE 3

The following example demonstrates some of the calculations and processes that may be used in a particular embodiment of the KXP process constructed in accordance with the present invention. No Header mode is included in this example, e.g., there is no Alphabet Transposition.

Initial Option

| | |
|---|---|
| Original ID = 0372 | (decimal) |
| EN = 0B372A65 | (hex) |

| | | | | |
|---|---|---|---|---|
| TE = 0EA9D5B2 from | 0 + 0 = 0 | 3 + B = E | 7 + 3 = A | 2 + 7 = 9 |
| and | | | | |

| | | |
|---|---|---|
| (0,0=B) + 2 = D | (B,3=B) + A = 5 | (3,7=5) + 6 = B |
| (7,2=D) + 5 = 2 | | |

| | | |
|---|---|---|
| Initial ES = 3E941BD175 | from | PK(0372BB26, 0B372A65) where (0,0=3) + 0 = 3 |
| (3,B=B) + 3 = E | ... | 9^{th} ES digit is (0,0 + 1 offset =7) + 0 = 7 |

10^{th} ES digit is (3,B + 1 offset=2) + 3 = 5

Key Exchange

| LKES KXPE(ES+ON)=SK KXPE(SK+NS)=OR | | | |
|---|---|---|---|
| | ES | 3E941BD175 | |
| | ON | B302CC178C | Known |
| | SK | E196D8E8F1 | (3+B), (E+3)... |
| | NS | 7F39A51826 | Generated |
| | OR | 50CF7DF017 | Known = (E+7), (1+F)... |

| | |
|---|---|
| NES | PK(NS, KXPE(ES+SK)) |
| | PK(7F39A51826, (3E941BD175 + E196D8E8F1)) |
| | PK(7F39A51826, 1F2AE3B966) |
| | (7,1=3) +7 = A (F,F=8) + F = 7 ... |
| | A7830B3077 |

Message Encrypt

| DK1′ | PK(ES,SK) |
|---|---|
| | PK(3E941BD175, E196D8E8F1) using Increment Method 2 |

(IM2) as SK(1) is even

(3,E=B) + 3 = E (E,1=4) + E = 2 ...11^{th} digit (3,(E+1

position)=1)=9) + 3 = C 12^{th} digit (E,9=E) + E = C

| | E2278CBE83CCE55E85A8 | |
|---|---|---|
| DK1 = | OWC(DK1′) using a Separation Value of 0 (adjacent | |
| | digits) in all OWCs | |
| | OWC(E2278CBE83CCE55E85A8) | |
| | (E+2) (2+7) ... | |
| | 0949B833D2 | |
| DK2′ | PK(SK, ES) | |
| | PK(E196D8E8F1, 3E941BD175) using Increment Method 1 | |
| | (IM1) as SK(1) is odd | |
| | (E,3=D) + E = B (1,E=E) + 1 = F ...11^{th} digit | |
| | ((E,3)=D+1position=8) + E = 6 12^{th} digit | |
| | ((1,E)=E+1P=8) +1 = 9 | |
| | BF25B0C9D969F757F67F | |
| DK2 = | OWC(DK2′) | |
| | OWC(BF25B0C9D969F757F67F) | |
| | (B+F) (2+5) ... | |
| | A7B56F6C56 | |
| LKES | KXPE(NS+DK1)=IS KXPE(IS+DK2)=NS′ | |
| | NS | 7F39A51826 |
| | DK1 | 0949B833D2 |
| | IS | 78725D4BF8 |
| | DK2 | A7B56F6C56 |
| | NS′ | 1F27BCA74E |

| | |
|---|---|
| MK | OWC(NS′) |
| | OWC(1F27BCA74E) |
| | (1+F) (2+7) ... |
| | 09712 |

Could use any cipher technique here with the MK. The KXP cipher:

| | |
|---|---|
| Message | Hello World! |
| | 48 65 6C 6C 6F 20 57 6F 72 6C 64 21 |

| MK-OTP | NEK(MK) |
|---|---|
| | NEK(09712) to return 24 values (using IM1, MK(1) |
| | being odd) |
| | (0,0=9)+0 = 9 (9,9=9) + 9 = 2 (7,7=0) + |

7 = 7

(1,1=0) + 1 = 1 (2,2=7) + 2 = 9 (0,0=9 +

| | |
|---|---|
| 1P = 7) + 0 = 7 | (9,9=9 + 1P = 7) + 9 = 0 ... |

92719700A31AE842B8220993
92 71 97 00 A3 1A E8 42 B8 22 09 93 to use as ASCII

key characters

| | |
|---|---|
| Ciphertext | Message XOR MK-OTP |

48 65 6C 6C 6F 20 57 6F 72 6C 64 21 XOR 92 71 97 00 A3 1A

E8 42 B8 22 09 93

DA 14 FB 6C CC 3A BF 2D CA 4E 6D B2

2factor Authentication System

This section specifies the 2factor Authentication System. It is an identity-based, message-independent, one-pass authenticated key establishment protocol. It is designed to fit within communications protocols for remote access. It is the only electronic authentication system with operational efficiency while incorporating the unique capability of updating the long-term authentication keys. This allows 2factor to be the only remote authentication system that can apply unique trusted credentials at any and every participant interaction. Long-term key update provides the first multi-message protection in a forward (next-message) direction along with standard break-backward Perfect Forward Secrecy protection to any message with a compromised (valid, but not correct) long-term key. The system also offers straightforward information-theoretic analytic proof that the applied mathematics provides unconditional security of plaintext exchanges.

1. Introduction

Mutual authentication and data security is easy to provide—for a closed, small group. Almost every current method available today will work, and it will work within almost any established benchmark criteria. These include certificate-based SSL, Public Key Infrastructures (PKI), tokens, SSH, etc.

But what if the group is large, fluctuating and ever expanding? What methods work then—what are the features needed to deliver that security? This type of group has several thousand or more participants with multiple and changing trust partners and end users. In order to meet the needs of these large groups, the authentication and data security system must meet well-defined benchmark criteria, providing:
The least number of components
   The fewest keys per participant
   The fewest key containers
   The fewest message route participants
   The fewest necessary computational devices
The most user-friendly participation
   The fewest installation and usage steps
The simplest installation and operation
   The fewest operational installation, usage and maintenance activities
The fastest communications performance
   The fastest authentication mechanism
   The smallest computational effort
The longest possible life cycle
   The smallest key size increases over time
   Provable math foundation not susceptible to future computing methods
The highest ROI
   LoW initial cost, loW component cost, loW support costs
   Best of Breed in all other criteria leads to highest ROI
The most flexibility
   The most generic capability leading to diverse application
   System design based on providing interchangeable functionality (authentication separate from encryption separate from RNG separate from authority control)
   The smallest code space for maximum device support
The best security (highest protection versus risk ratio)
   Strong, simple two factor Authentication (high bit, short lived credential)

Current authentication and data security methods that work on small groups have difficulty scaling to large groups. This is because they begin to add too many components, require too much end user expertise, demand too many resources to operate, perform too slowly with too much computational overhead, provide limited futures due to necessary key size increases and mathematic insecurity and are too costly when compared to the actual security needs of the data transmissions and data ownership.

2factor was specifically designed to deliver mutual authentication and data security for all groups. Even though the criteria are not market apparent for the small groups, the inability of the current methods becomes a stark reality for large ones. The following chart shows the comparison of 2factor and the best features of the current mutual authentication solutions:

| | | | | SSL/PKL/ |
|---|---|---|---|---|
| Feature | Component | Requirement | 2factor | Tokens |
| # of keys/ | Key | Fewest | 1 | 3 |
| participant | Management | | | |
| # of transmissions/ | Performance | Fewest | 1 | Over 10 |
| msg | | | | |
| Outside trust | Key Mgmt/ | Fewest | None | 1 or more |
| partners | Perf | | | |
| Computational | Performance | Fewest | None | Required |
| aids | | | | |
| Authentication | Performance/ | Fastest | Fast (1) | SloW (8-50) |
| Speed | Security | | | |
| Key Size | Security | Smallest | 1 byte | Key |
| Increases | | | | doubling |
| Code Size | Performance | Smallest | <10K | >60K |
| Provable | Security | Desired | Yes | No |
| Mathematics | | | | |

2. Conventions and Terminology

The 2factor description is a concrete process that can easily be fitted to a particular application. The specific implementation details, such as key storage methods and interconnectivity options, are left to the protocol implementer to decide, although some examples are included in this description.

The only particular convention for 2factor is key formatting. 2factor uses keys as numbers—this is crucial to providing the intended security of the system. This requirement is not limiting since any bit-stream can be segmented for use as key numbers in 2factor. Using each 4-bits of the stream to represent a hexadecimal number accomplishes this. In the case of a bit-stream leaving any 4-bit segments predictably (such as where the most-significant 4-bits are all 0, etc.), then one must carefully choose the significant 4-bits to be used such that an unpredictable (e.g., random) base key is chosen.

3. The 2factor Authentication and Data Security System (2factor)

The following is the 2factor method for its identity-based, message-independent, authenticated key establishment protocol:

Setup

1. There is a central repository (2factor store, or 2store), openly located, in which a set of credentials (keys), are stored for each participant. The number of keys is dependent on the implementation of the 2factor system. In the following method description, key credentials are labeled ID# where # will be the appropriate credential for the implementation as defined below, or an explicit # for a particular step.
a. The keys are numbers where each digit is represented in 4-bit hex; each is currently recommended (as of 3/04) to be 256-bits long, 64 digits. The keys must be an even number of digits, and can be any size, as there is no set requirement.
b. Two pairs are kept, minimally, per participant; the original version, and the latest version, identified by a Message ID (MID).
c. The participants received their keys (2factor Credentials or IDs) securely.
d. The keys are stored with definitive administrator-only access in the 2store repository using a classic black-box configuration.

2. Any new numbers (keys or interim values) are created by a secure PRNG.

3. All calculations are simple add without carry (modular addition) using single digit positions of any input; full results are concatenation of all the single digit results.

Method

Concise Description:

Setup: Each 2factor participant is securely in receipt of two 2store authentication credential keys, ID1 and ID2, each 256-bits, 64 hex digits currently (4-bit representation)

The mathematic equations of the 2factor protocol are (shown in two successive messages):

| Message 1 | Message 2 |
|---|---|
| 1. S₁ + ID1₁ = OR₁ | 7. S₂ + ID1new₁ = OR₂ |
| 2. ID2₁[S₁] = IDtemp₁ | 8. ID2new₁[S₂] = IDtemp₂ |
| 3. IDtemp_{1left} + IDtemp_{2right} = W₁ | 9. IDtemp_{2left} + IDtemp_{2right} = W₂ |
| 4. AES(Msg, W₁) = CT₁ | 10. AES(Msg, W₂) = CT₂ |
| 5. S₁[ID2₁] = ID1new₁ | 11. S₂[ID2new₁] = ID1new₂ |
| 6. ID2₁[ID1₁] = ID2new₁ | 12. ID2new₁[ID1new₁] = ID2new₂ |

Where
   S is a random per-message salt
   ID1 and ID2 are the original 2factor n-bit credentials
   ID1new and ID2new are the next expected n-bit credentials
   W is the unique message key
   AES is the chosen data security cipher
   X[Y] represents a number permuted upon itself using simple add without carry arithmetic (see PDAF description to follow)
1. PRNG generate a new salt, S, add without carry it in each single digit position to ID1 resulting in an open value called the Open Return, OR
2. Calculate a parent session key (IDtemp) by performing a Position Digit Algebra Function (PDAF) with S and ID2. A PDAF (fully described below) simply adds without carry each sequential position value of ID2 with the value to the right of that value as pointed to by each sequential position of S
3. Create a child session key, W, by cutting in half the PDAF result of step 2 by adding without carry each set of digit pairs. W would then be 128-bits, 32 digits. The cut is called a One-Way Cut (OWC)
4. Perform one of the following two different Step 4's, dependent on the plaintext communication:
   If Unknown, Numeric Plaintext (P)
Add without carry the plaintext, P with the child session key, W, resulting in the ciphertext CT
   If Any Other Bit-Stream Plaintext (Msg)
Use W in a cipher encryption (AES currently) of a plaintext message, Msg, resulting in ciphertext CT.
5. Update ID1 using a PDAF with ID2 pointing into S, resulting in ID1 new.
6. Update ID2 using a PDAF with ID1 pointing into ID2 resulting in a ID2new
7. Send OR, CT to the intended recipient
8. For next message, start with ID1new and ID2new

Full Explanation of the Method, Including all Data Element-Handling Options:

1. Generate New Salt (S) and Create Open Return (OR):

Generate salt S (in the same base as ID1) and add without carry ID1 to S in each single digit position, concatenating all results into OR, a known public value of equal length to ID1:
(ID1[i . . . n]+S[i . . . n]) Mod baseID1=OR[i . . . n]

2. Parent Session Key Generation:

Execute an add without carry step, hereinafter referred to as the Position Digit Algebra Function, or PDAF, which adds ID2 with other position digits of ID2 as selected by S to return a parent session key, IDtemp. The base value ID2 is called the Value Key (VK), and the selection value S is called the Offset Key (OK):

First set a pointer to select each digit of ID2. Then select another digit from a different position in ID2 to add to the pointer value where the ID2 position value is selected by another pointer that is moving through S in the identical manner. Position selection counting is performed with position zero as the first position to the right of the current position in ID2, position one is the second position to the right, etc. The pointer in S identifies an S value that determines which new offset position from the current position in ID2 to use to select the position-digit value. Do this for each position in ID2, circling around ID2 to select values if S's selection goes “off the right end”, concatenating all results into IDtemp. Cycle around S and repeat from the start if shorter than ID2. [The function, in principle, can return any length, where the OK is used cyclically, and for each cycle through the VK, the position of either VK or OK (either of the two methods) is incremented by one. Upon reaching a return length of VK², there are unique ways to update VK and OK and repeat; such as adding without carry some or all of the individual cycle return values for VK and simply using one of them as a new OK. Performing several long return versions of short input PDAF values, added without carry together and XORed with plaintext, does have the property of returning statistically sound random ciphertext. In essence, the PDAF can be a PRNG under certain circumstances; it is not used as such in this definition of 2factor. Using this property, though, can extend the parent session key, creating new child keys as in the next step, without the further creation and overhead of continual salt values in Step 1. This is extremely beneficial for specific implementations where there is a need to limit the production of overhead value exchange such as fast wireless voice encryption, etc.]
(ID2[i]+ID2[((i+S[i]) Mod Length_{—}ID2)+1]) Mod baseID2=IDtemp[i] . . .
(ID2[n]+ID2[((n+S[n]) Mod Length_{—}ID2)+1]) Mod baseID2=IDtemp[n]
Ex. If ID2=302458 and S=237390, then IDtemp=78747B where
when i=1, (ID2[1]+ID2[((1+S[0]) Mod 6)+1]) Mod 16=IDtemp[ ],
which is (3+ID22[(3+1)]) Mod 16=IDtemp[1], which is (3+4) Mod 16=7;
when i=2, (ID2[2]+ID2[((2+S[2]) Mod 6)+1]) Mod 16=IDtemp[2],
which is (0+ID2[(5+1)]) Mod 16=IDtemp[2], which is (0+8) Mod 16=8; . . . remainder resulting in (2+5), (4+0), (5+2) and (8+3) for IDtemp=78747B

This step is notated: PDAF(ID2[i . . . n], S[i . . . n])=IDtemp[i . . . n] or PDAF(ID2,S) or ID2[S]=IDtemp

3. Child Session Key Generation:

Add without carry the digit pairs of IDtemp (choosing any system defined separation value, SV, such as adjacent digits where SV=1) resulting in a unique, one-time child session key W, which will half the length of the parent session key IDtemp. This is called a One-Way Cut function (OWC), and is notated OWC(IDtemp):
(IDtemp[i]+IDtemp[i+SV]) Mod base IDtemp=W[i] . . . (IDtemp[n−SV]+IDtemp[n]) Mod base IDtemp=W[n/2 which is notated j]

The digits are never reused in this halving step; therefore, as the pairs are selected, one must ‘jump’ to the next unused digit. If the SV=2, then the I st digit is paired with the 3rd, then the 2nd with the 4th, and then one must jump to pairing the 5th with the 7th, etc. When the SV is chosen such that pair selection leaves digits ‘at the end of IDtemp’ that have not been selected yet do not fit the ‘jumping’ pattern, simply pair these digits adjacently. The ‘jump’ is found by (SV*2)+1; therefore, the last length_of_IDtemp (mod SV*2) digits would be paired adjacently.

4. Content Encryption:

This step has two different types of plaintext that can be operated on: Option A.) Numeric plaintext that is unknown to the receiver (repetitive or non-repetitive), and Option B.) Any other bit-stream plaintext. There are different steps to be performed for each:

A. If Unknown, Varying Numeric Plaintext (Option A)

The plaintext must be a number (P[i . . . j]) not longer than the length of W. Add without carry P and W, resulting in the ciphertext, CT, a known public value (bold):
(P[i . . . j]+W[i . . . j]) Mod baseW=CT[i . . . j]

B. If Any Other Bit-Stream Plaintext (Option B)

Perform the current best-of-breed cipher using session key W:
E(Msg, W)=CT for example, using AES: AES(Msg, W)=CT

5. Generate First New Long-Term Key:

Perform a PDAF using S and ID2, resulting in ID1new:
(S[i]+S[(i+ID2[i]+1) Mod Length_{—}S]) Mod baseID2=ID1new[i] . . . (S[n]+S[[(n+ID2[n]+1) Mod Length_{—}S]) Mod baseID2=ID1new[n]
which is PDAF(S, ID2)=ID1new or S[ID2]=ID1new

6. Generate Second New Long-Term Key:

Perform a PDAF using ID2, and ID1 resulting in ID2new:
(ID2[i]+ID2[(i+ID1[i]+1) Mod Length_{—}ID2]) Mod baseID1=ID2new[i] . . . (ID2[n]+ID2[[(n+ID1[n]+1) Mod Length_{—}ID2]) Mod baseID1=ID2new[n]
which is PDAF(ID2, ID1)=ID2new or ID2[ID1]=ID2new

7. Send the Message to the Intended Recipient:

All messaging participants are known by an OpenID, such that any recipient will know which starting key ID1 to use for decryption. This OpenID will be given at “registration”. Also, for message auditing and tracking purposes, each message should have a unique Message Identification (MID), either a random or sequenced tag (number, alphanumeric, etc.). These, along with the public outputs from the process above, are sent from Sender (A) to the Recipient (B).
A→B: MID, OpenID, OR, CT

8. Recipient Decryption:

Decryption by Recipient B, is an identical symmetric process based on the shared knowledge of the starting keys ID1 and ID2 (the shared secrets). The reverse of the add without carry, such as using OR to generate S in Step 1:
((baseID1+OR)−ID1) Mod baseID1=S

The Step 4 differences in decryption:
A. ((baseP+CT)−W) Mod baseW=P
   Ciphertext P would be vulnerable to nuisance tampering, so a 2factor Message Authentication Code (ID-MAC) as defined beloW must accompany this exchange.
B. D(CT, W)=Msg for example, using AES: AES(CT, W)=Msg Successful decryption authenticates the exchange and knowledge of ID1

9. Next Message Generation:

Repeat above using ID1new and ID2new in Step 1 as the new long-term starting keys.

Message Authentication Code (ID-MAC Process) for Numeric Plaintext Messages:

Unknown numeric exchanges (Step 4A) are vulnerable to tampering—no knowledge is leaked, but nuisance interventions and dropped bits during communication can cause problems. Using a Message Authentication Code (MAC) process so the values received can be shown as those intended by the sender solves this type of problem. 2factor can accommodate any existing MAC process using hash algorithms, etc. Those will need to be used for alphanumeric messages, but it is possible (and simpler) to use the following ID-MAC process to ensure correct numeric ciphertext delivery. The ID-MAC value is transmitted along with the MID, OpenID, CT and OR. Changes in any CT or OR will be detected and known:

1. Perform an add without carry of S and the CT numeric ciphertext
MACTemp1[i . . . j]=(CT[i . . . j]+S[i . . . j]) Mod baseS

2. Perform a PDAF using the parent session key, IDtemp, and MACTemp1 returning n-digits (a length equal to ID1)
MACTemp2=PDAF(IDtemp, MACTemp1)

3. Perform an OWC on MACTemp2, returning j-digits (a length equal to w)
ID−MAC=OWC(MACTemp2)
Key Size Recommendations for Proper 2factor Security:

The following are the recommended current ID#s sizes as of the publication date of this paper (March 2005):
All ID#s=256-bits, represented in 64 4-bit hexadecimal numbers
Session Key Wwill therefore be 128-bits (32 4-bit hex numbers)

Note that the combined 512-bits of 2factor ID#s key lengths is half the current 1024-bit recommended size for PKE keys. The 2factor methodology only requires keys of even-digits; there is no necessity or required sizes or size increases or decreases. The ID# sizes can certainly increase in blocks as small 8-bits (2 digits). The effect (performance, storage, etc.) of the key size increases in 2factor is infinitesimal in comparison to block cipher necessitated increases, as well as PKE method key size increases.

A Cyclic Example of the 2factor Method: Unknown Numeric Plaintext
P=53
ID1=017D
ID2=4F61 —

### Numeric Plaintext Encrypt

Encrypt—Step 1
Salt(S)=DC8A
(0+D) Mod 16=D, (1+C) Mod 16=D, (7+8) Mod 16=F, (D+A) Mod 16=7 resulting in OR=DDF7

Encrypt—Step 2
(0+7) Mod 16=7, (1+7) Mod 16 8, (7+D) Mod 16=4, (D+7) Mod 16=4 resulting in IDtemp=7844

Encrypt—Step 3
(7+8) Mod 16=F, (4+4) Mod 16=8 resulting in W=F8

Encrypt—Step 4A-i
(5+F) Mod 16=4, (3+8) Mod 16=B resulting in CT=4B

Encrypt—Step 5
(D+C) Mod 16=9, (C+C) Mod 16=8, (8+C) Mod 16=4, (A+C) Mod 16=6 resulting in ID1new=9846

Encrypt—Step 6
(4+F) Mod 16=3, (F+1) Mod 16=0, (6+6) Mod 16=C, (I+F) Mod 16=0 resulting in ID2new=30C0

### Numeric Plaintext Decrypt

Decrypt—Step 1 (Same ID1, ID2 Knowledge)
((16+D)−0) Mod 16=D, ((16+D)−1) Mod 16=C, ((16+F)−7) Mod 16=8, ((16+7)−D) Mod 16=A resulting in Salt (S)=DC8A

Decrypt—Step 2
(0+7) Mod 16=7, (1+7) Mod 16=8, (7+D) Mod 16=4, (D+7) Mod 16=4 resulting in IDtemp=7844

Decrypt—Step 3
(7+8) Mod 16=F, (4+4) Mod 16=8 resulting in W=F8

Decrypt—Step 4A-i
((16+4)−F) Mod 16=5, ((16+B)−8) Mod 16=3 resulting in P=53

Decrypt—Step 5
(D+C) Mod 16=9, (C+C) Mod 16=8, (8+C) Mod 16=4, (A+C) Mod 16=6 resulting in ID1new=9846

Decrypt—Step 6
(4+F) Mod 16=3, (F+1) Mod 16=0, (6+6) Mod 16=C, (1+F) Mod 16=0 resulting in ID2new=30C0
ID1 is then 9846 and ID2 is then 30C0 in the next cycle.
   2store Message Transfer:

In order to limit any 2factor system messaging participant to a single key, as desired by most end-users, it is a simple process to connect distributed 2factor 2stores. This connectivity can be through the entirety of a 2store, through just a limited portion, through key format pass-through, etc. After 2store owners have established the key-sharing paradigm, then message transfer for A to B, through their respective 2stores, is simply:
A→2Store_{A}: MID₁, OpenID_{A}, OR_{A}, CT_{A} 2store_{A}: Decrypts to reveal session key W_{A}, used in CT_{A} 2store_{A}→2store_{B} MID₂, OpenID_{KDC}_{_{A}}, OR₂ₛₜₒᵣₑ_{_{A}}, OR₂ₛₜₒᵣₑ_{_{A}}, CT[i . . . j]₂ₛₜₒᵣₑ_{_{A}}, CT_{A} where CT[i . . . J]₂ₛₜₒᵣₑ_{_{A}} is small numeric encryption of W_{A}
2store_{B}: Decrypts to reveal session key W₂ₛₜₒᵣₑ_{_{A}}, used in CT[i . . . j]₂ₛₜₒᵣₑ_{_{A}} which then decrypts to reveal original session key W_{A}, used in CT_{A} 2store_{B}→B MID₃, OpenID_{B}, OR₂ₛₜₒᵣₑ_{_{B}}, CT[i . . . j]₂ₛₜₒᵣₑ, CT_{A} where CT[i . . . j]₂ₛₜₒᵣₑ_{_{B}} is small numeric encryption of W_{A}
B: Decrypts to reveal session key W₂ₛₜₒᵣₑ_{_{B}}, used in CT[i . . . j]₂ₛₜₒᵣₑ_{_{B}} which then decrypts to reveal original session key W_{A}, used in CT_{A}, which is then decrypted to reveal original plaintext from A

The transfer is simple and efficient, only decrypting to the point of revealing the appropriate session key for each transfer, until reaching the final destination where the intended 2factor participant performs the final, bulk decryption of the original ciphertext. The original, full ciphertext is simply passed through any 2store until arriving at the intended destination—or even sent directly on to the final destination, if possible.

Lost or Dropped Messages:

2factor updates the long-term ID# keys. This additional security feature requires an opponent to store the entire message chain for cryptanalysis. It also entails the possibility of lost or corrupted messages, which would disrupt the key update chain, leaving two participants with different expected ID# start values—and the inability to decrypt. This can be dealt with in several ways; three mentioned here, with the obvious out-of-band delivery of new keys always an option:

1. If only two versions of each ID# are stored, one should be the original version under a MID of zero (or some other system defined base value), and the other should be the last version. When a recipient cannot decrypt a received message, perform the following:
A→B: MID₁, OpenID_{A}, OR₁, CT₁
B→A: LOST_KEY_FLAG, MID_{select} where MID_{select} identifies the previous message's ID1 value to use in a resend
A→B: MID₂, OpenID_{A}, OR₂, OR₃, CT₂ where OR₂ indicates that Steps 1 and 2 in the procedure have been recomputed using MID_{select}'s starting ID1, creating a new S, then using the new parent session key IDtemp as the new ID1new and then using that in a second entire 2factor yielding OR₃ and CT₂

2. If multiple versions of each ID# are stored, one should be the original version, and the others, the last versions. When a recipient cannot decrypt a received message, perform as in the first recovery above, but identify any of the stored MID values as the MID_{select} to reference that ID#.

3. At original distribution, send a third key, ID3. When a LOST_KEY_FLAG is sent, use ID3 in a PDAF with each of the original ID1 and ID2 to generate new starting values. Update ID3 to a new value by either a PDAF or add without carry with either the new ID1 or ID2.

Tokenized Authentication:

The 2factor method provides embedded authentication using the message key W and the resulting ciphertext. But there are applications where an authentication token verification check may be desired (for speed, etc.) Using the interim calculated value IDtemp in a PDAF with W creates a W-length token that can be sent with each 2factor exchange and validated quickly before performing any actual decryption on the accompanying ciphertext. Adding this equation and open result has no impact on the underdetermined equation set security, while adding an easy and fast authentication verifier outside of the embedded ciphertext. (Using the AES cipher on IDtemp with Was the key can also be performed).

ID Storage:

See the black-box approach to 2store protection detailed in Appendix C.

Multiple Location ID Use:

2factor provides the ability to place the same original ID credentials on multiple participant devices. This saves the end user time and effort, but places a certain formatting restriction on all messages sent using the original set (without any leaked information for a passive or active opponent). The restriction is due to the cyclic updating of the long-term ID keys, and once each location has begun a chain, the 2store must recognize the message as starting a new one; adding another OID-linked stored ID set and MID) sequence. This is done using the above same format for the receipt of a re-started chain due to a lost key or message except that the identifying MID is different (and there is no prior LOST_KEY message):
A→B: MID₁, OID_{A}, OR₁, OR₂, CT₁ where OR₁ indicates that the current keys have been computed using the OID original starting ID1, creating a first S, then using the new parent session key ID1newtemp as the new ID1new and then using that in a second entire 2factor process as the starting key and then yielding OR₂ and CT₁. The steps in shorthand notation:
   1. S1+ID1-O1=OR1
   2. ID2−O1[S1]=ID1newtemp1
   3. S2+ID1newtemp1=OR2
   4. ID2−O1[S2]=IDtemp1
   5. IDtemp1left+IDtemp1right=W1
   6. AES(Msg1, W1)=CT1
   7. S2[ID1−O1]=ID1new1
   8. ID2−O1[ID1−O1]=ID2new1

This format notifies the 2store (through the format and content of MID₁ or a flag of some kind) that it should start by using the OID's original ID1 key and continue from that point, creating a new chain for this location. The only information that can be determined from capturing and analyzing all of the multi-location sends for the same OID-ID original keys is that S₁ is up or down in value in each position from the others. It does nothing to help actually determine any ID# following key or the makeup of the original ID1 key. It should be noted that this method can also be used at any location to “self heal” the key cycle upon a lost or dropped key exchange; instead of going back to a previous MID, a participant simply begins again using the OID's values. The knowledge of attempting to store large sequences of data and watching S₁ in relation to ID1-O₁ is of no value. See the Appendix A.

4. Security Considerations

This section discusses an authentication and key-exchange system that protects data communications and exchanges keys across an untrusted network. This system improves security by eliminating the need for computationally expensive and multi-keyed public key systems for authenticating key exchanges and creating secure session keys for data encryption. It also removes the need for multiple transmission symmetric key exchange protocols where the exchange basis is again computationally expensive mathematics or low-entropy passwords. This system accomplishes identical logic basics as existing authentication and key exchange systems, while adding a new fundamental improvement in protection of future messages.

Appendix A provides specific detailed mathematics on the security as well as the binomial probability discussion for future message authentication and protection even with compromised long-term credentials. Appendix B provides a description of the 2factor defeats of both authentication and key-establishment attacks. Appendix C provides descriptions of original key distribution techniques as well as key storage (2store) security options.

### Appendix A

2factor offers two a new security capability heretofore nonexistent in any cryptographic system: future protection of messages even with a compromised long-term credential. This future protection will be called Future Secrecy (FS).

Function Properties:

There are two distinct 2factor function types, with associated mathematic and cryptographic properties. The function types and their properties:
1. Add without carry the digit pairs for a half-length result (One-Way Cut)
   a. Unique identification of the initial value cannot be positively determined from a discovered cut value to anything more definitive than a subset of the initial key space (10% for decimal, 6.25% hexadecimal, which for both is a value ½ the length of the initial value). The next message must be captured and broken to provide any further information.
2. The Position Digit Algebra Function (PDAF)
   a. There are multiple pairs of input values [VK(OK)] for any same-length singular output value making reverse definitive identification of either input value impossible.
   b. Brute force of input values for an n-digit PDAF result requires a 2n key space search (both VK and OK required to be attempted).
   c. Even with one of the inputs and the result being known values, there is a large work factor to determine the small subset of possibly correct second input values, with verification of the correct value requiring further message capture and break.
   d. Using truly random inputs (suitable PRNG values), the output result of a same-length PDAF is unique from either input, without bias or predictability.
   e. The PDAF as a single-step non-linear permutation function removes the need for certain other cryptographic properties, such as diffusion, because of the way it is used on a specific data type (numbers), and the method used to produce that data type.
      2factor Information-Theoretic Security:

In combining these two simple functions into the 2factor system of equations, a straightforward information-theoretic analytic proof that the applied mathematics provides unconditional security of plaintext exchanges can be given. For the bit-stream plaintext data security approach (Step 4C), a simple analysis is hereby provided by Jianhua Yuan, Ph.D. Candidate, Department of Operations Research & Financial Engineering, Princeton University:

The 2factor system is based on OWC, PDAF, and simple addition w/o carry. And the underlying mathematical system is also quite straightforward as follows:

Let C be the total number cycles, B be the common base for all numbers, N, an even number, to be the length of S, ID1, ID2, and IDtemp(W, CT, and the plaintext are of length N/2).
1. Open Return
   (S(i,j)+ID1(i,j)) mod B=OR(i,j)
1<=i<=N, 1<=j<=C
2. cipher text processing
   (ID2(i,j)+ID2((i+S(i,j)) mod N+1,j)) mod B=IDtemp(i,j)
   (IDtemp(2k−1,j)+IDtemp(2k,j)) mod B=W(k,j)
   AES(Msg, W)=CT
1<=i<=N, 1<=j<=C, 1<=k<=N/2

3. create new keys
(S(i,j)+S((i+ID2(i,j)) mod N+1, j)) mod B=ID1(i,j+1)
(ID2(i,j)+ID2((i+ID1(i,j)) mod N+1,j) mod B=ID2(i,j+1)
1<=i<=N, 1<=j<=C−1

The above mathematical system is clearly an integral system with single-digit variables.

Now given the security of the AES, we can see that this system is irreducible because we always have more unknown variables than the equations. In each intermediate cycle, there are 4.5N equations and 4.5N variables (w/o the equation AES(Msg,W)=CT). For the last cycle, we have 2.5N equations and 2.5N variables. For the initial cycle, there are 4.5N equations and 6.5N variables. Hence no matter how many cycles are operated, the system remains underdetermined. The total number of possible solutions to this system will be B to the power of 2N.

In conclusion, this primitive analysis showed the irreducibility of the 2factor system.

The same integral analysis applies to the security technique used by 2factor on varying numeric data (Step 4A). Future Secrecy for alphanumeric bit streams

General bit-stream encryption is performed using the best-of-breed cipher in Step 4C of 2factor because alphanumeric bit stream data can be recognized when one attempts decryptions (as opposed to numbers, which cannot be discerned). The session key W derived in the cut function in Step 3 is one-half the length, a small percentage of the key space, of a full ID2. Attacks against the bit-stream data can be done by:
1. Brute force of W or ID2 where W is set to be substantially ‘impossible’ (impractical for a specified time interval; as 128-bits is currently); therefore the brute force of ID2 is truly irrational.
2. Breaking the best-of-breed cipher (this includes all known and unknown cryptanalytic attacks); protection of W is provided by the encryption capability, and married to it.
3. Breaking the PRNG—but any 2factor implementation is assumed to use an adequate and cryptographically secure model.

The only other type of attack on 2factor for alphanumeric bit streams is to attempt some kind of manipulation (break) of the PDAF such that the work is less than W's key space work. As the function is simply a series of an extremely high number of underdetermined equations, there is no mathematical method to “attack” the function to have it produce a correct (or even valid) result in anything less than the key space of the sought-after result. Additionally, it is not reasonable to assume that one could guess a correct PDAF result any sooner from the longer input values than one could just guess the shorter result (brute-force). And as the PDAF is married to the OWC function, which “cuts out” the correct W out of the PDAF result pool, the same size W pool is in the PDAF inputs to search for from the start at minimum. Therefore, in order to break any message's W, there is at least W-length's key space of work no matter how one attacks the protocol.

The message cycle:

Message 1

1. S₁+ID1₁=OR₁
2. ID2₁[S₁]=IDtemp₁
3. IDtemp_{1left}+IDtemp_{2right}=W₁
4. AES(Msg, W₁)=CT₁
5. S₁[ID2₁]=ID1new₁
6. ID2₁[ID1₁]=ID2new₁
   Message 2
7. S₂+ID1new₁=OR₂
8. ID2new₁[S₂]=IDtemp_{2right}=W₂
9. IDtemp_{2left}+IDtemp_{2right}=W₂
10. AES(Msg, W₂)=CT₂
11. S₂[ID2new₁]=ID1new₂
12. ID2new₁[ID1new₁]=ID2new₂

In the cyclic use of the 2factor credentials, the remaining security question is whether once one has a correct W through some means, can one find the correct current ID1 and ID2 keys? Even if one found the correct W through an exhaustive key search, it should be noted that there is no way to positively determine whether the starting ID1 and ID2 are the absolutely correct values, or just a pair of the valid values, through S. And if one found W by breaking the cipher, it is impossible to discover the correct full ID1 and ID2 makeup by reverse-traversing the OWC. One must have another message—either the immediately preceding message, or the immediately succeeding message. If one does not have either one, the work factor of breaking W has been completely lost, since S, and therefore ID1 and ID2 have been randomly re-drawn with no mathematical way to interpret or correlate them to any previous knowledge.

But if one does have an immediate message, preceding or succeeding, the partial knowledge of S, ID1 and ID2 might help. The knowledge would be an ability to have to attempt a shortened key space because only certain combinations of ID1 and ID2 and S would work in creating a valid IDtemp (ID1 and S are linearly connected). The problem then becomes the PDAF reset of the next ID1 and ID2. Even with a smaller S space to work with, the full ID1 and ID2 key spaces are the defining field for the establishment of their PDAF results. And of course, a new random S will be applied further disabling the ability to connect the discovered W to the next message, even though it is connected to the PDAF result.

If one obtains knowledge of a W, all of the factors just mentioned produce a binomial probability of having any correct W digit leading to an S digit pair (accurate knowledge can never be more definitive than a pair possibility) leading on to the next W formation. The binomial probability can range all the way from only one pair being correct through to the next W, or a few different pairs, or even all pairs being correct. And of course, the probability is unique to each pair (as the formation of the pairs “to the right” directly affect the correctness of those to the left when the PDAF “shuffles” them). It is likely that it can be shown that the binomial probability never gets to 1 in every pair (e.g., that the full ID1 and ID2 are known), but it most certainly can be known that the odds of the combined binomial probability of every digit pair having a correct unique solution in only one subsequent message are quite substantial; possibly even as high as simply guessing the next W near its bound (2128).

The exercise of establishing the exact binomial odds will be left to others, because the work factor of determining the exact two starting keys is obviously not trivial and requires some kind of break of the underlying cipher to gain knowledge of the session key. It is already a substantial improvement over existing systems to require multiple exact sequential message captures and breaks. All other systems completely fail upon the discovery of a single message's upper level key, and the binomial distribution problem presented by 2factor is a considerable improvement. Whether the binomial probability is definitively more than the next W's key space of 2128, it is definitely not trivial. This 2factor Future Secrecy capability is a substantial improvement in authenticated key-establishment and content encryption.

### Appendix B

2factor provides protection against known authentication and security protocol attacks and attack strategies, as indicated in the table below:

| | 2factor Peer-to-Peer | |
|---|---|---|
| Attack (Type and/or | (P2P) | 2factor Peer-to-Store- |
| Strategy) | Defeat | to-Peer (P2S2P) Defeat |
| Man-in-the-Middle (Key | As a single secret, one-pass | Each pass is a shared- |
| Establishment attack - | protocol, an opponent must | secret, one-pass |
| KEA) | know the secret | transmission; in-the-middle |
| | | requires knowledge of at |
| | | least one end's key |
| Impersonation | Must have credentials | Same |
| (Identification Protocol | knowledge | |
| Attack - IPA) | | |
| Misplaced server trust | Meaningless in P2P | Symmetric key stores are |
| (KEA) | | vulnerable to stolen and |
| | | then false presentation |
| | | (false presentation w/o |
| | | actual key store is |
| | | meaningless). The |
| | | infrastructure is the key to a |
| | | defeat of this tactic, and |
| | | 2factor's recommended |
| | | black-box approach |
| | | severely limits this |
| | | possibility |
| Replay (IPA) | Credentials are updated | Same |
| | upon each use | |
| Interleaving (KEA and IPA) | One-pass, and chained | Same |
| | updating disallows | |
| | interleaved combinations of | |
| | ongoing and/or past info | |
| Reflection (KEA and IPA) | One-pass, so no | There is no response |
| | challenge/response to reflect - | anywhere in the message |
| | also, single key is updated | tree, so reflection to others |
| | and is new in each pass (uni- | won't garner any |
| | directional) | information |
| Forced Delay (IPA) | Nuisance on delay, but no | Same |
| | information gained nor | |
| | changed - can certainly | |
| | use/embed time-stamp | |
| | information/other timing | |
| | techniques to defeat | |
| Chosen-text (IPA) | Each message has a new | Same |
| | self-generated random | |
| | number (S), a confounder. | |
| | So this only applies by | |
| | intercepting a transmission | |
| | and holding it, then forging | |
| | a LOST-KEY response to | |
| | get sender to resend using | |
| | Original Credentials, and | |
| | then correlating the two | |
| | outputs. There is no | |
| | vulnerability to numeric | |
| | plaintext, as this remains | |
| | unconditionally secure; | |
| | alphanumeric relies on the | |
| | cipher strength - and each of | |
| | the two messages still have | |
| | unique keys, so defeated in | |
| | the usual sense | |

### Appendix C

The following are provided as examples of the type of infrastructure and process security methods that can and should be used such that 2factor is properly implemented and retains the security provided by the method:

Remote Key Distribution:

The process to originally, and positively singularly, distribute the IDs to new participants should be performed by a method resulting from a cost/risk/capability analysis. As the entirety of the 2factor system is a remote authentication and secure transmission method, it is essential that the IDs be properly derived from (belong to) the truly authentic participant. There are “perfect” ways to do this, including personal hand-offs (which even these can be non-perfect, hence the quotes). There are also “hour glass” methods, which are single-use reliance on some secondary system for the one-time distribution (e.g., using SSL over the Internet, email, etc.). The IDs should be distributed after the total system security is analyzed and the risks of individual improper access through duplicated or stolen IDs are evaluated. Then the distribution method, or methods, should be selected.

It should be noted that in certain applications of a 2factor system and the accompanying IDs, the value is not in having the credentials, but in duplicating them. For instance in a financial transaction implementation, the value is in the credit card or account money, which is wrapped within the IDs. Because in all instances of the 2factor method one must be moving in the chain of updated IDs to be certain of the currently correct values, and because the 2factor system never allows re-use of any IDs, stealing an ID and using them in place of the real ID owner is meaningless. Duplicating—along with the requirement of capturing and storing every single transmission—can be problematic in terms of passively reading transactions, but having and using someone else's is not.

When performing this cost/risk/capability analysis, it is important to include a professional security analyst who is accustomed to authentication attacks and attack strategies. It is incredibly easy to misstep in blissful ignorance while establishing this crucially important initial distribution system by inserting a gaping security hole. For instance, every single authentication system is entirely susceptible to a complete spoofing of the whole process to an unsuspecting new participant without some kind of required widely available and easily verifiable public value within the process, such as a phone number to call in. The ability and motivation of any adversary to the system being secured must not be underestimated. Establish this initial distribution system carefully.

The following is an example of a fairly secure remote initial distribution system for IDs. It requires phone phreaking, email snooping and SSL sniffing/breaking in order to passively or actively attack and duplicate/steal a new participant's credentials:
1. A new participant who is expected to join the system goes to their known 2factor website, which is running a version of SSL to secure the browser, and registers
2. Keys, ID1 and ID2, are PRNG created by the 2store for that new participant
3. A welcome message is created with an Open ID (OID) that publicly identifies the participant as a 2factor member, along with ID1 and ID2. This message is encrypted with a PRNG created Cipher Key (AES or any other cipher), which is held temporarily in the 2store for this OID.
4. The encrypted welcome message is emailed to the new participant, with their OID included un-encrypted. Simultaneously, a PIN is sent over the SSL connection to the participant and placed as a cookie on their machine.
5. The participant then is expected to phone a known public number within a short time interval, enter the PIN, and receive the Cipher Key (this will be either 10, 20 or 30 hex digits, corresponding to 40, 80 and 120-bits, in sets of 5, where each set receipt is re-entered into the phone for confirmation)
6. The new participant then re-enters an “Unlock Credentials” section of the website and enters their OID. The 2store repository then responds by sending a servlet (or JSP) to execute on the participants machine into which the encrypted section of the welcome email is cut and pasted (or auto opened by the servlet, if possible), and the Cipher Key is entered. The servlet will also ask the participant for a PIN that will securely store the credentials onto this machine (this PIN can be different in each place that the participant follows this procedure and stores the credentials—which can be used multiple times in multiple locations). The servlet will then decrypt the contents, ID1 and ID2, and place these credentials PIN protected in an add without carry, along with the OID into either a file or cookie or some standard place.
7. Each time the participant uses the 2factor system from this device, the 2store will send a servlet to operate locally, ask the participant for the PIN, gather and decrypt the credentials from the standard place and then use them in the 2factor process for authentication; updating them on this machine as required. The PIN may be changed at any time—but it is imperative that the participant remember them or else the credentials will be unusable until and unless the participant redoes this process to get new ones (in which case the current ones will be removed from the system).

This initial distribution process is pro-active in that the participant will need to perform some steps—but is quite simple in that the steps do not require high-tech device knowledge for things like software installation, etc. It only requires two website visits, a phone call, writing down some temporary numbers, and re-entering these into the device (but these are not the actual credential numbers). An opponent needs to perform email snooping (the encrypted credentials), phone phreaking (the PIN entry and Cipher Key receipt), and SSL sniffing/breaking (the PIN receipt) in order to passively or actively attack and duplicate/steal a new participant's credentials.

Black-Box Storage Configuration:

It is of paramount importance that a stolen 2store does not completely compromise the system. The logical and positively provable way to accommodate a stolen 2store is to only place encrypted credentials within the store, such that without the Operating Key or Keys, possession of the repository is completely meaningless. This is simple to accomplish with the numeric 2store key formats and a simple add without carry operation upon the ID contents using a larger-than-the-largest-ID-value Operating Key or Keys. A repository encrypted in this manner mathematically reveals absolutely no knowledge about the true ID values within the 2store. There is also no performance problem in a simple one-step add without carry operation on any fetched and stored ID.

The infrastructure setup of this logical operating practice is then the “key” to the success of maintaining the security of the 2store. It does no good to hold the Operating Key(s) within the same machine as the 2store, nor does it work to hold those keys in the memory of the machine: they must be held physically separate, and operationally separate from the 2store. This is easily accomplished by the use of a “black-box” into which is loaded the Operating Key(s) and which has a single process running in which a ID is sent into the box, an add without carry encrypt or decrypt is performed using the Operating Key(s), and out is sent the properly formatted ID for an active 2factor process reconciliation or storage. The security of the 2store is then dependent on the properly formatted singular access to operate the black box, the maintenance and security of the administrator list of personnel who can and will load the Operating Key(s) into the box, and the physical separation and security of it. The principle is that the black-box is a single use, single process, single access “machine” that is easily separated and securely maintained, whereas the 2store might have millions of members (and records) and be physically available across many machines and network/infrastructure operations.

This type of system is routinely performed in military operating environments, is well documented in multiple and different configurations, and can itself be an audit trail for any outside “breaks” of the system: one knows where to look and whom to look for should a stolen and compromised 2store ever surface. The entirety of the ability to utilize this type of security approach for the IDs revolves around the simplicity, speed and simple configuration of the fetch/store add without carry process: if this added a performance bottleneck, the 2factor system would not scale (which is definitely the case with zero-knowledge and Asymmetric Key Exchange systems). A black-box 2store configuration, with acceptably formatted, routinely cyclic and closely guarded Operating Key(s) is a perfect method for the protection of any sized 2factor authentication system implementation. [The use of multiple Operating Keys can be done in two different and possibly combined ways: the first is to have multiple different-keyed black-boxes such that there are sequentially encrypted stages of fetch/store; and the second is to have different keys protecting different sections of the 2store, possibly with different access into the different sections. See documented black-box configurations.]

Although various embodiments are specifically illustrated and described herein, it will be appreciated that modifications and variations of the present invention can be made on the basis of the above teachings and are within the purview of the appended claims without departing from the spirit and intended scope of the invention.

What is claimed is:

1. A method for communicating securely, comprising:
converting an original secret into a first key set comprising a first plurality of keys;
converting a first key of the first key set into a first message key through the use of a first linear and digit-position-based one-way function;
replacing the original secret with a second key of the first key set; and
using the second key of the first key set as a first new secret for a subsequent communication.

2. The method according to claim 1, further comprising encrypting message content using the first message key.

3. The method according to claim 2 wherein, after the first message key is used to encrypt message exactly content once, the new secret is converted into a second key set comprising a second plurality of keys.

4. The method according to claim 3, wherein a first key of the second key set is converted into a second message key by using a second linear and digit-position-based one-way function.

5. The method of claim 4, wherein the first and second functions are the same.

6. The method of claim 4, wherein the first new secret is replaced with a second of the second plurality of keys, thereby defining a second new secret for use in the next communication.

7. The method according to claim 2, wherein the first message key is used to encrypt the message content by
(a) first expanding the first message key into a first expanded message key comprising paired numbers, wherein each pair of numbers represents a byte of information, and
(b) using the first expanded message key to encrypt the message content.

8. The method according to claim 7, further comprising:
creating a transpose matrix;
creating a header key unique from the first expanded message key by operating on the first expanded message key with the first function;
expanding the header key into an expanded header key; and
using the header key in an XOR operation with a unique alphabet order such that the transpose matrix is hidden in a one time pad.

9. The method according to claim 8, further comprising the steps of:
passing plaintext of the message content through the transpose matrix, thereby creating transposed plaintext; and
performing an XOR operation with the transposed plaintext and the expanded message key to create a transposed and keyed ciphertext.

10. The method according to claim 1, wherein the original secret comprises a number with an even number of digits that is at least ten digits in length.

11. The method according to claim 1, wherein the original secret comprises a number with an even number of digits that is at least twenty digits in length.

12. The method according to claim 1, wherein the step of converting the original secret into the first key set includes performing a sequence of a plurality of linear operations on each digit of the original secret.

13. The method according to claim 1, wherein the step of converting the original secret results in a first key set which can only be uniquely determined with knowledge of the original secret.

14. The method according to claim 1, wherein the first key set includes at least three keys.

15. The method according to claim 8, wherein the step of expanding the message key is performed by one of a plurality of selectable techniques, and wherein the message includes a header which identifies the particular technique used.

16. The method according to claim 15, wherein the header also indicates the number of digits of the first message key that are used to encrypt the message content.

17. A method for encrypting a message, comprising:
establishing secret A, which is a number with an even number of digits that is at least 10 digits in length;
converting each digit Aₖ of secret A into another value Aₙ through the use of the following formulas:
(Aₖ+a) Mod q=Bₖ; and
(Bₖ+Cₖ) Mod q=Aₙ;
wherein q is hexadecimal or decimal, the two formulas use each single corresponding digits of A, B, and C, and C is randomly created by the sender;
generating a random number Y which is twice as long as a system required message encryption strength;
cutting the random number Y in half through the modular addition of adjacent digits;
using the reduced random number as a message key to encrypt a language-based message;
expanding the message key;
cutting the expanded message key in half through the modular addition of adjacent digits to create Header Key;
expanding the header key;
adding a header including variables to indicate which of a plurality of techniques was used to expand the header key, the length of the message key and, if a one time pad was used, the length of the one time pad;
building a random, one-time transpose matrix of ASCII elements;
passing a plaintext message through transpose matrix to create a transposed plaintext;
encrypting the transpose matrix using the extended header key in an exclusive OR operation to create an encrypted header output;
encrypting the transposed plaintext using the extended message key in an exclusive OR operation to create a ciphertext output; and
converting C for a subsequent message by transposing the digits in C with a digit-position-based one-way function to create a converted C, and then using the converted C as a next A in a subsequent communication.

18. The method of claim 17, wherein the message further includes a transmitter ID which identifies the transmitter.

19. A method for encrypting a message, comprising:
establishing secret A, which is a number with an even number of digits that is at least 10 digits in length; converting each digit Aₖ of secret A into another value Aₙ through the use of the following formulas:
(Aₖ+a) Mod q=Bₖ; and
(Bₖ+Cₖ) Mod q=Aₙ
wherein q is hexadecimal or decimal, the two formulas use each single corresponding digits of A, B, and C, and C is randomly created by the sender;
generating a random number Y which is twice as long as a system required message encryption strength;
cutting the random number Y in half through the modular addition of adjacent digits;
using the reduced random number as a message key to encrypt a language-based message;
expanding the message key;
cutting the expanded message key in half through the modular addition of adjacent digits to create a header key;
expanding the header key;
adding a header including variables to indicate which of a plurality of techniques was used to expand the header key, the length of the message key and, if a one timepPad was used, the length of the one time pad;
building a random, one-time transpose matrix of ASCII elements;
passing a plaintext message through transpose matrix to create a transposed plaintext;
encrypting the transpose matrix using the extended header key in an exclusive OR operation to create an encrypted header output;
encrypting the transposed plaintext using the extended message key in an exclusive OR operation to create a ciphertext output; and
converting C for a subsequent message by transposing C's digits by a digit-position-based one-way function and then using the converted C value as a next A in a subsequent communication.

20. A method, applicable to a system for exchanging secure communications based on an existing secret wherein each communication within the system contains a message identification number, for randomly and indecipherably exchanging a new secret upon demand to be used to replace an existing secret, the method comprising:
providing a first number and a message identification number;
providing an operator that is a function of first and second variables;
providing a matrix lookup function which, on the basis of at least one given input number, uniquely determines a set of indices, and returns the element of a matrix defined by those indices;
operating on the first number and the message identification number with the operator to generate a second number;
generating first and second index numbers by applying the matrix lookup function to first and second digits, respectively, selected from the second number;
operating on the sum of the two index numbers with the operator, thereby generating a result; and
replacing the existing secret with the result.
